(19) United States
(12) Patent Application Publication
(10) Pub. No.: US 2012/0057785 A1
(43) Pub. Date: Mar. 8, 2012

(54) METHOD AND SYSTEM TO MODIFY A COLOR LOOKUP TABLE

(76) Inventors: Peter Morovic, Barcelona (ES); Jordi Vilar, Barcelona (ES); Jordi Arnabat Benedicto, L'Arboc (ES); Jan Morovic, Colchester (GB); Manuel Angel Albarran Moyo, Barcelona (ES)

(21) Appl. No.: 12/876,939

(22) Filed: Sep. 7, 2010

(51) Int. Cl. G06K 9/00

(52) U.S. Cl. 382/167

(57) ABSTRACT

The present disclosure provides a computer-implemented method of generating a modified color lookup table (CLUT) based on an original image, a profile connection space (PCS) image, and an adjusted image. The method includes, for each PCS pixel of the PCS image, identifying a subset of CLUT nodes corresponding to the PCS pixel. The method also includes identifying a color shift between an original pixel of the original image and an adjusted pixel of the adjusted image, wherein the original pixel and the adjusted pixel are co-located with the PCS pixel. The identified the color shift is associated with each one of the subset of CLUT nodes. For each CLUT node, a combined color shift is determined based on the color shifts associated with the CLUT node. A modified CLUT can be generated based on the combined color shifts computed for each of the CLUT nodes.

### BACKGROUND

An International Color Consortium (ICC) profile is a data structure that enables an electronic color device, such as a computer monitor, printer, camera, scanner, and the like, to represent and render colors in a consistent, accurate, and repeatable manner and predict device colorimetry. ICC profiles contain conversion tables, known as color lookup tables (CLUTs), which define a mapping between a device independent color space and a device specific color space. A color lookup cable may be generated, for example, by a device manufacturer to provide an accurate reproduction of colors for that specific device. Although the ICC profile may provide an accurate reproduction of colors, a user of the device may prefer a different color reproduction than the color lookup table provides.

### BRIEF DESCRIPTION OF THE DRAWINGS

Certain embodiments are described in the following detailed description and in reference to the drawings, in which:

FIG. 1 is a block diagram of a computing device that may be used to generate a modified color lookup table, in accordance with embodiments of the present invention;

FIG. 2 is a diagram of a portion of the profile connection space, in accordance with embodiments of the present invention;

FIG. 3 is a diagram of a portion of the device space, in accordance with embodiments of the present invention;

FIG. 4 is a process flow diagram of a method of modifying a color lookup table in accordance with embodiments of the present invention; and

FIG. 5 is a block diagram showing a non-transitory, computer-readable medium that stores code configured to generate a modified color lookup table, in accordance with an embodiment of the present invention.

### DETAILED DESCRIPTION OF SPECIFIC EMBODIMENTS

Embodiments of the present invention provide a method of modifying a color lookup table (CLUT), such as an International Color Consortium (ICC) profile color lookup table. In accordance with embodiments, a color lookup table may be modified based on a comparison of an unadjusted image and an adjusted image. The unadjusted image may be a digital image generated, for example, by a digital camera. A user of a specific display device may then generate an adjusted image by altering the colors of the unadjusted image, for example, by changing the color saturation levels of certain colors to suit the user's preferences. The adjustments applied to the image are the intended changes in the final output of the display device. Further, the image adjustments are constrained to the proofed device gamut. Thus, both the unadjusted and adjusted displayed images are proofs of the output without and with the adjustment.

Color adjustments applied to the adjusted image may be color-local adjustments, for example, changing the saturation of the blues. Color adjustment may also be color-global adjustments, for example, changing the overall tone curve or contrast across all colors. The unadjusted image and the adjusted image may be electronically processed to extract the color differences between the unadjusted image and the adjusted image. The extracted color differences may be used to modify the color lookup table in accordance with the user's color adjustments. The modified color lookup table may then be used to provide consistent and repeatable color reproduction that exhibits the user's color preferences. Furthermore, if some color adjustments are not consistent across the image, in other words, if the same colors are not adjusted equally in different regions of the image, those divergences will be averaged in resulting modified color lookup table.

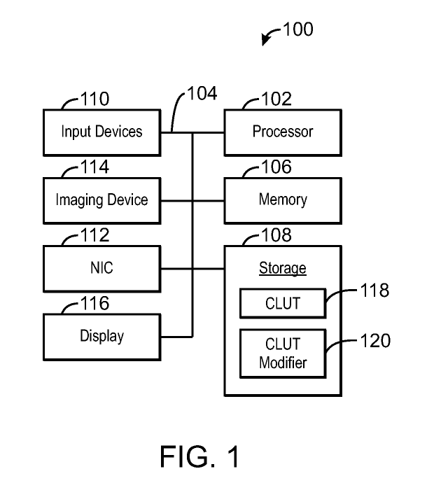

FIG. 1 is a block diagram of a computing device that may be used to generate a modified color lookup table, in accordance with embodiments of the present invention. The computing device is generally referred to by the reference number 100. Those of ordinary skill in the art will appreciate that the functional blocks and devices shown in FIG. 1 may comprise hardware elements including circuitry, software elements including computer code stored on a non-transitory, computer-readable medium, or a combination of both hardware and software elements. Further, the configuration is not limited to that shown in FIG. 1, as any number of functional blocks and devices may be used in embodiments of the present invention. Those of ordinary skill in the art would readily be able to define specific functional blocks based on design considerations for a particular electronic device.

As illustrated in FIG. 1, the computing device 100 may include a processor 102 connected through a bus 104 to one or more types of non-transitory, computer readable media, such as a memory 106 that may be used during the execution of various operating programs, including operating programs used in embodiments of the present invention. The memory 106 may include read-only memory (ROM), random access memory (RAM), and the like. The computing device 100 can also include other non-transitory, computer readable media, such as a storage system 108 for the long-term storage of operating programs and data, including the operating programs and data used in embodiments of the present invention. The storage system 108 may include, for example, hard disks, CDs, DVDs, flash memory, and the like.

The computing device 100 can also include one or more input devices 110, such as a mouse, touch screen, and keyboard, among others. The device 100 can also include a network interface controller (NIC) 112, for connecting the device 100 to a network through a local area network (LAN), a wide-area network (WAN), or another network configuration. In an embodiment, the computing device 100 is a general-purpose computing device, for example, a desktop computer, laptop computer, business server, and the like.

The computing device 100 can also include, or be operatively coupled to, an imaging device 114, for example, an optical scanner, digital camera, and the like. The imaging device 114 may be used to capture images which may be processed according to the techniques described herein. Captured images may be stored to the memory 106 or the storage system 108 in a device independent color space or format. In the context of ICC color management, the device independent color space is referred to herein as the profile connection space (PCS) and may be either CIE LAB or CIE XYZ. In other embodiments, any other suitable device independent color space may be used.

The computing device also includes a display 116. As used herein, the term “display” refers to any device that can display a visual image, for example, a computer monitor, an LCD screen, and the like. Furthermore, although the present techniques are described in the context of displays, it will be appreciated that the present techniques may also be applied to other imaging devices, such as printers. The display can include or be associated with a color lookup table 118 configured to map device independent colors of stored images to the device specific color space of the display device 116. The device specific color space may be referred to herein as a “device space.” For example, the device space may be an RGB color space or a CMYK color space, among others. The color lookup table 118 may be specific to the corresponding display 116 and may be included in an ICC color profile stored, for example, in a memory included in the display or the storage device 108.

The color lookup table 118 may be a conversion table that defines the mapping between the PCS color values and device space color values. The color values of both the profile connection space and device space may be represented as a set of color coordinates that represent a point within the multi-dimensional color spaces. For a color lookup table that maps between the PCS color space and the RGB color space, the color lookup table may be three-dimensional for both color spaces. For a color lookup table that maps between the PCS color space and a CMYK color space, the color lookup table will be three dimensional in the PCS color space and four dimensional in the CMYK color space. For the sake of clarity, the present techniques may be described in reference to three dimensional color spaces. However, it will be appreciated that other multi-dimensional color spaces are within the scope of the present invention.

Each color coordinate has several corresponding color attributes, such as hue, saturation, brightness, and the like. The color lookup table 118 may be indexed by PCS color values, each index pointing to a corresponding device space color value. To display an image on the display device, each pixel of the image may be converted from the profile connection space to the device space by inputting the PCS pixel color value, and obtaining the corresponding device space color value as an output. The color lookup table may include a plurality of nodes, referred to herein as “CLUT nodes,” which represent a sampling of both the profile connection space and device space. The division number of the color lookup table may be 9×9×9, 17×17×17, 33×33×33, and the like. Each CLUT node defines a mapping from a specific color in the profile connection space to a specific color in the device space. If an input PCS color value matches the PCS color value of one of the CLUT nodes, the output will be the corresponding device space color specified by the CLUT node. If the input PCS color value lies between CLUT nodes, the CLUT nodes nearest to the input PCS color value are identified and an interpolation process may be performed to obtain the color components of the corresponding device space output. The interpolation process may be trilinear or tetrahedral depending on the number of dimensions of the device space. The CLUT nodes nearest to the PCS color may be referred to as “interpolation nodes.”

The computing device 100 also includes a color lookup table modifier 120 configured to generate a modified color lookup table that captures user preferences for color reproduction, in accordance with embodiments of the present invention. As described further below, the color lookup table modifier 120 may be configured to determine a user's color preferences by comparing an original image and an adjusted image to identify the color shifts applied to the adjusted image. The identified color shifts may be used to adjust the CLUT nodes so as to incorporate the user's color preferences. Furthermore, because some of the color shifts will be applied to colors that lie between CLUT nodes, a weighting algorithm is used to determine the relative effect that each color shift has on the neighboring CLUT nodes. A weighted average of all of the color shifts applicable to each CLUT node may be used to modify the color lookup table.

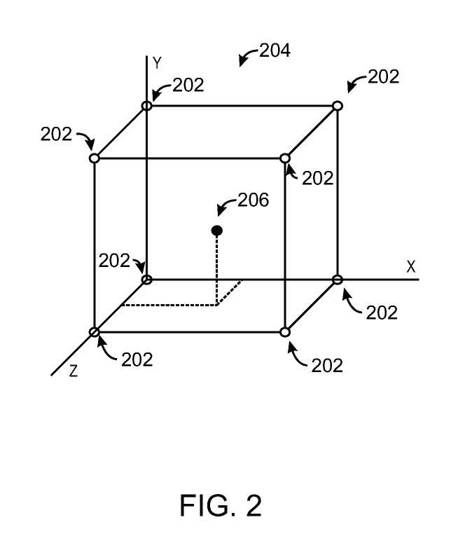

In an embodiment, the modification of the color lookup table 118 uses three related images. The first image, referred to herein as the “original image,” may be a visual image encoded in the device space such as Adobe RGB or sRGB. The pixels of the original image may be referred to as “original pixels.” The second image, referred to herein as the “PCS image,” may be the original image converted to the profile connection space. The pixels of the PCS image may be referred to as “PCS pixels.” The third image, referred to herein as the “adjusted image,” may be obtained by making color modifications to the original image and is also encoded in the device space. The color modifications can include color shifts in one or more of the color components of the adjusted image as compared to the original image. The pixels of the adjusted image may be referred to as “adjusted pixels.” The techniques described herein may be better understood with reference to FIG. 2.

FIG. 2 is a diagram of a portion of the profile connection space, in accordance with embodiments of the present invention. FIG. 2 shows a selection of eight CLUT nodes 202 whose PCS color values encompass a portion of the profile connection space. Each CLUT node 202 also specifies a corresponding color in the device space (not shown). The arrangement of CLUT nodes 202 may be referred to as a CLUT cube 204. For purposes of clarity, FIG. 2 also shows an X-axis, Y-axis, and a Z-axis. It should be noted that the X-, Y-, and Z-axis labels are arbitrary and are not intended to correspond with the X, Y, Z color components of the CIE XYZ color space, as any suitable color space may be used in accordance with embodiments. Furthermore, although the color lookup table corresponding to the CLUT cube 204 is three-dimensional, it will be appreciated that embodiments of the present invention are not limited to three dimensional color spaces. The distance between neighboring CLUT nodes 202 may be referred to as the sampling interval, which may be determined by the bit-depth used to encode the respective color spaces and the number of CLUT nodes used to represent the profile connection space and device color spaces. Each CLUT node 202 may be associated with a corresponding data structure, to which color shifts may be stored. For example, the data structure may be an array, a data table, or a portion of a data table corresponding to the CLUT node 202.

FIG. 2 also shows a PCS pixel 206, which represents a point within the profile connection space corresponding to a color value of one of the pixels in the PCS image. The CLUT nodes 202 of the CLUT cube 204 are the nearest neighbors with respect to the PCS pixel color and may be referred to herein as the “interpolation nodes” of the PCS pixel color. To determine the color shifts applied to each CLUT node, each PCS pixel 206 of the PCS image may be processed to identify the interpolation nodes corresponding to the pixel's color value as shown in FIG. 2 by the CLUT cube 204. The color shifts identified for the co-located pixels in the original image and adjusted image may be applied to each of the corresponding CLUT nodes 202 that have been identified as interpolation nodes with respect to the co-located PCS pixel 206. In an embodiment, the color shifts applied to each of the CLUT nodes 202 may be weighted based on the proximity of the pixel 206 to the corresponding CLUT node 202.

The weights identified for each CLUT node 202 may correspond to a relative distance between the pixel 206 and the corresponding CLUT node 202, and may be expressed as vector coordinates corresponding to the relative location of the pixel 206 in the profile connection space. The weights may also be normalized by the sampling interval and inversely proportional to the distances such that the weight will be higher if the pixel 206 is closer to the corresponding CLUT node 202. For the three dimensional color space shown in FIG. 2, the weights may be computed using trilinear interpolation techniques that are known in the art. In embodiments wherein the tessellation, or segmentation, of the color space is tetrahedral, then tetrahedral interpolation may be used. The weight may be the same as the interpolation weight which would have been assigned to the CLUT node had it been used in an interpolation scheme on the PCS pixel.

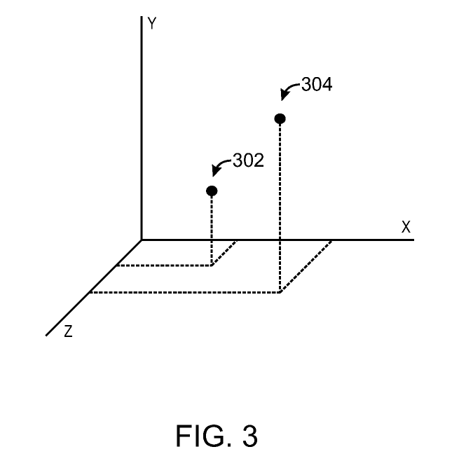

FIG. 3 is a diagram of a portion of the device space, in accordance with embodiments of the present invention. FIG. 3 shows an original pixel 302 and an adjusted pixel 304, both of which represent color values within the device space. The original pixel 302 represents a color of one of the pixels in the original image, and the adjusted pixel 304 represents a color of a co-located pixel in the adjusted image. The distance and direction between the pixels represents the color shift between the pixels, which resulted from the color adjustment that was made to the original image to generate the adjusted image. The color shift between the original pixel 302 and the adjusted pixel 304 may be identified by computing the difference between the pixel values in each color component.

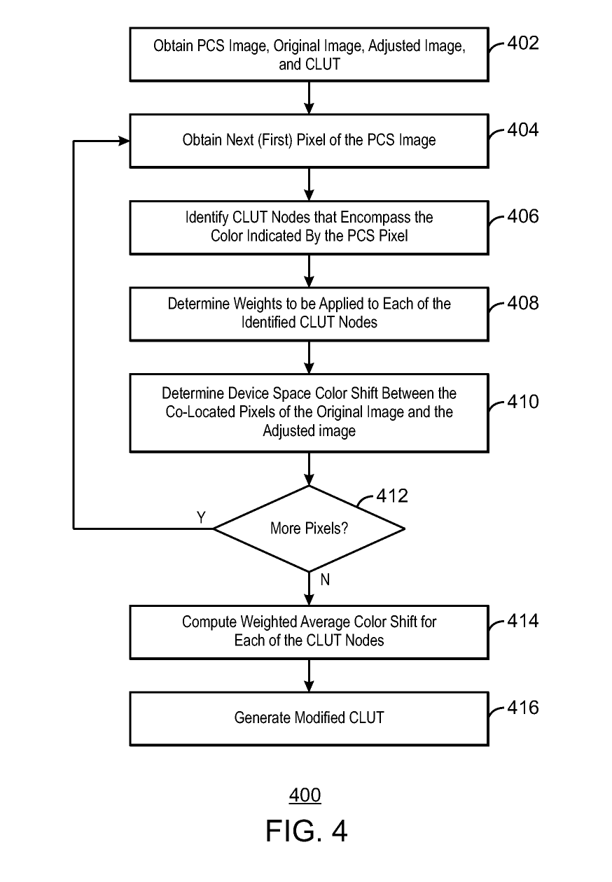

FIG. 4 is a process flow diagram of a method of modifying a color lookup table in accordance with embodiments of the present invention. The method may be referred to by the reference number 400 and may be executed by the color lookup table modifier 120. The method may begin at block 402, wherein the PCS image, the original image, and the adjusted image may be obtained. The original image may be any type of digital image such as a photograph generated by the imaging device 114 and encoded in the device space. The original image may also be an image obtained through the network, for example, from the Internet. The original image may also be a test image supplied, for example, by a manufacturer of the display 116 to enable the discovery of a user's color preferences.

The PCS image may be obtained by converting the original image into the device independent profile connection space using the color lookup table 118. The adjusted image may be obtained by applying color modifications to the original image. For example, the color modifications may be made by a user of the computing device 100 to obtain an image that better suits the user's preferences for color reproduction on the display 116. The color adjustments may be generated through the use of an image processing tool such as Photoshop®, or a color management utility, for example, provided by a manufacturer of the display 116. The color modifications made to the original image may include changes to the hue or saturation level, contrast, exposure or tone curves and others. In an embodiment, the color modifications are global, meaning that the color modifications are applied to the image as a whole, regardless of the location or region that a particular color is located within the image.

In an embodiment, the original image and the adjusted image can be processed by the color lookup table modifier 120 to determine whether spatial adjustments exist between the original image and the adjusted image. A spatial adjustment is a color adjustment that is applied to only a portion of the image rather than the image as a whole. For example, a spatial adjustment may include red-eye reduction, air-brushing, or any other color adjustment that is applied to a subset of pixels of the original image. Techniques for identifying a spatial color adjustment are described in the co-pending, commonly assigned patent application Ser. No. ______, titled “Method and System to Determine Whether an Image Includes Spatial Adjustments” by Peter Morovic et al., filed on ______, which is hereby incorporated by reference in its entirety for all purposes.

In an embodiment, if a spatial adjustment exists between the original image and the adjusted image, the process flow may terminate and the color lookup table may be left unchanged. Additionally, a warning message may be displayed to the user indicating that the color lookup table modification could not proceed. In an embodiment, the user may be provided the option of proceeding despite spatial adjustments. In such cases, the resulting color lookup table modification will be an average of the various spatial adjustments. For example, if a seaside picture has the blue of the ocean adjusted by boosting saturation while the blue sky remains unadjusted, the result might be an overall but milder boost of saturation of all blues. If no spatial adjustment exists between the original image and the adjusted image or if the user chooses to proceed despite spatial adjustments, the process flow advances to block 404.

At block 404, a pixel of the PCS image is obtained. At block 406, the CLUT nodes that encompass the color indicated by the PCS pixel value are identified, as described in relation to FIG. 2. The identified CLUT nodes are the interpolation nodes for that PCS pixel. At block 408, the weights to be applied to each of the CLUT nodes of the CLUT cube are computed, as described in relation to FIG. 2. The weights are used to weight the corresponding color shift identified for the co-located pixels of the original image and the adjusted image.

At block 410, the device space color shift between the co-located pixels of the original image and the adjusted image may be identified. The pixels are described as co-located, because the pixels of the PCS image, the original image, and the adjusted image are located at the same point in all three images. The device space color shift may be obtained as described in relation to FIG. 3. Also at block 410, a weighted color shift may be computed for each of the CLUT nodes identified at block 406, based on the device space color shift and the weight computed for the corresponding CLUT node. For example, the device space color shift may be multiplied by each of the weights computed for each of the CLUT nodes. The weighted color shift for a specific CLUT node may be stored to the data structure corresponding to that CLUT node. In this way, a record of the color shifts applicable to each CLUT node may be stored for later processing.

At block 412, a determination is made regarding whether there are remaining pixels in the PCS image that have not yet been processed. If there are additional pixels remaining to be processed, the process flow may advance to block 404, wherein the next pixel is obtained from the PCS image. If all of the pixels have been processed, the process flow may advance to block 414.

At block 414, a combined color shift is computed for each of the nodes of the corresponding color lookup table. The combined color shift for a particular CLUT node may be based on the color shifts stored to the CLUT node's data structure. In this way, the combined color shift for a particular CLUT node may be based on all the color shifts computed for the pixels that have color values for which the CLUT node is a vertex of the interpolation cube. In an embodiment, the combined color shift computed for each CLUT node may be an average of all of the weighted color shifts computed for the CLUT node. For example, the average weighted color shift for a CLUT node may be computed by the following formula:

$$\frac{{\sum }_{i = 1}^{N} {W}_{i} {S}_{i}}{{\sum }_{i = 1}^{N} {W}_{i}}$$

In the above formula, Wᵢ is the weight computed for the i^{th} pixel, Sᵢ is the shift computed for the i^{th} pixel, and N is the total number of PCS pixels for which the CLUT node is a nearest neighbor, which may be determined by the number of color shifts stored to the CLUT node's data structure.

At block 416, the color lookup table 118 may be modified based on the combined shifts computed for the CLUT nodes. For example, the combined color shift computed for a particular CLUT node may be added to the original device space color value specified by the CLUT node. The PCS color values by which the color lookup table is indexed may remain unaltered. In this way, the modified color lookup table provides a mapping between the profile connection space and the device space in a way that better represents the user's color reproduction preferences. Modifying the color lookup table 118 may include editing the existing color lookup table 118, or generating a new color lookup table with the modified device space color value values.

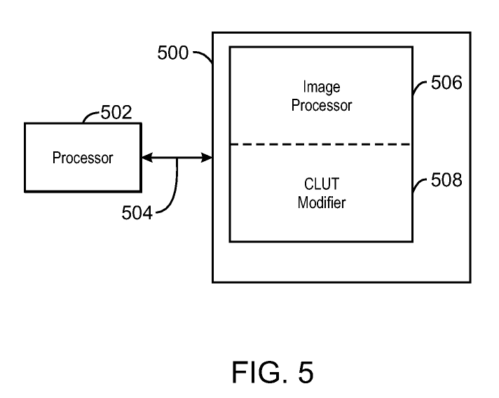

FIG. 5 is a block diagram showing a non-transitory, computer-readable medium that stores code configured to generate a modified color lookup table, in accordance with an embodiment of the present invention. The non-transitory, computer-readable medium is referred to by the reference number 500. The non-transitory, computer-readable medium 500 can comprise RAM, a hard disk drive, an array of hard disk drives, an optical drive, an array of optical drives, a non-volatile memory, a universal serial bus (USB) drive, a digital versatile disk (DVD), a compact disk (CD), and the like. The non-transitory, computer-readable medium 500 may be accessed by a processor 502 over a communication path 504.

As shown in FIG. 5, the various components discussed herein can be stored on the non-transitory, computer-readable medium 500. A first region 506 on the non-transitory, computer-readable medium 500 can include an image processor configured to receive an original image comprising a visual image encoded in a device dependent color space. The image processor can covert the original image to a PCS image encoded in a device independent color space using a color lookup table comprising a plurality of CLUT nodes. The image processor can also enable a user to generate an adjusted image by adjusting the colors of the original image. A region 508 can include a color lookup table modifier configured to generate a modified color lookup table based on the color adjustments identified between the original image and the adjusted image. For each pixel of the PCS image, the color lookup table modifier may be configured to identify a subset of CLUT nodes that comprise interpolation nodes corresponding to a color of the PCS pixel. The color lookup table modifier can identify a color shift between an original pixel of the original image and an adjusted pixel of the adjusted image, wherein the original pixel and the adjusted pixel are co-located with the PCS pixel. The color lookup table modifier may also be configured to store the color shift to a set of CLUT node data structures, wherein each data structure corresponds to one of the CLUT nodes in the subset of CLUT nodes. For each CLUT node, the color lookup table modifier may be configured to determine a combined color shift of the CLUT node based, at least in part, on the color shifts stored to the corresponding the CLUT node data structure. The color lookup table modifier may also be configured to generate a modified color lookup table based on the combined color shifts computed for each CLUT node.

What is claimed is:

1. A method, comprising:
receiving an original image, a profile connection space (PCS) image, and an adjusted image;
for each PCS pixel of the PCS image:
identifying a subset of color lookup table (CLUT) nodes corresponding to the PCS pixel;
identifying a color shift between an original pixel of the original image and an adjusted pixel of the adjusted image, wherein the original pixel and the adjusted pixel are co-located with the PCS pixel; and
associating the color shift with each one of the subset of CLUT nodes;
for each CLUT node, determining a combined color shift based on the color shifts associated with the CLUT node; and
generating a modified CLUT based on the combined color shift computed for each of the CLUT nodes.

2. The method of claim 1, comprising, for each PCS pixel, computing a weight for each one of the subset of CLUT nodes, wherein the weight corresponds to a distance in a device independent color space between a color of the PCS pixel and a PCS color specified by the corresponding CLUT node, wherein the weight is used to modify the color shift associated with the corresponding one of the subset of CLUT nodes.

3. The method of claim 2, wherein computing a weight for each CLUT node comprises:
identifying a color value difference in the device independent color space between the PCS pixel and the CLUT node;
computing an interpolation weight which would have been assigned to the CLUT node had it been used in an interpolation scheme on the PCS pixel.

4. The method of claim 2, wherein the color shift associated with each CLUT node is a weighted color shift computed by multiplying the weight corresponding to the CLUT node by the color shift identified for the PCS pixel.

5. The method of claim 4, wherein the combined color shift of the CLUT node comprises an average weighted color shift computed by averaging together all of the weighted color shifts corresponding to the CLUT node.

6. The method of claim 1, wherein identifying a color shift between the original pixel and the adjusted pixel comprises identifying a device space color value difference between the original pixel and the adjusted pixel.

7. The method of claim 1, comprising identifying whether the adjusted image includes spatial modifications as compared to the original image.

8. A computer system, comprising:
a processor that is configured to execute computer-readable instructions; and
a memory device that stores instruction modules that are executable by the processor, the instruction modules comprising a CLUT modifier configured to:
receive an original image, a profile connection space (PCS) image, and an adjusted image;
for each PCS pixel of the PCS image:
identify a subset of color lookup table (CLUT) nodes corresponding to the PCS pixel;
identify a color shift between an original pixel of the original image and an adjusted pixel of the adjusted image, wherein the original pixel and the adjusted pixel are co-located with the PCS pixel; and
associate the color shift with each one of the subset of CLUT nodes;
for each CLUT node, determine a combined color shift based on the color shifts associated with the CLUT node; and
generate a modified CLUT based on the combined color shifts computed for each of the CLUT nodes.

9. The computer system of claim 8, wherein the CLUT modifier is configured to, for each pixel of the PCS image, compute a weight for each one of the subset of CLUT nodes, wherein the weight is proportional to a distance in a device independent color space between a color of the PCS pixel and a PCS color specified by the corresponding CLUT node and wherein the weight is used to modify the color shift associated with the corresponding one of the subset of CLUT nodes.

10. The computer system of claim 9, wherein computing a weight for each one of the subset of CLUT nodes comprises identifying a color value difference in the device independent color space between the PCS pixel and the CLUT node and performing a trilinear interpolation or tetrahedral interpolation.

11. The computer system of claim 9, wherein the color shift associated with each CLUT node is a weighted color shift computed by modifying the color shift identified for the pixel by the weight corresponding to the CLUT node.

12. The computer system of claim 11, wherein the combined color shift of the CLUT node comprises an average weighted color shift computed by averaging together all of the weighted color shifts corresponding to the CLUT node.

13. The computer system of claim 8, wherein identifying a color shift between the original pixel and the adjusted pixel comprises identifying a device space color value difference between the original pixel and the adjusted pixel for each color component.

14. The computer system of claim 8, wherein the CLUT modifier is configured to identify whether the adjusted image includes spatial modifications as compared to the original image.

15. A non-transitory, computer readable medium, comprising instruction modules configured to direct a processor to:
receive an original image, a profile connection space (PCS) image, and an adjusted image;
for each PCS pixel of the PCS image:
identify a subset of color lookup table (CLUT) nodes corresponding to the PCS pixel;
identify a color shift between an original pixel of the original image and an adjusted pixel of the adjusted image, wherein the original pixel and the adjusted pixel are co-located with the PCS pixel; and
associate the color shift with each one of the subset of CLUT nodes;
for each CLUT node, determine a combined color shift based on the color shifts associated with the CLUT node; and
generate a modified CLUT based on the combined color shifts computed for each of the CLUT nodes.

16. The non-transitory, computer readable medium of claim 15, comprising instruction modules configured to direct the processor to, for each pixel of the PCS image, compute a weight for each one of the subset of CLUT nodes, wherein the weight corresponds to a distance in a device independent color space between a color of the PCS pixel and a PCS color specified by the corresponding CLUT node; wherein the weight is used to modify the color shift associated with the corresponding one of the subset of CLUT nodes.

17. The non-transitory, computer readable medium of claim 16, wherein computing a weight for each one of the subset of CLUT nodes comprises identifying a color value difference in the device independent color space between the PCS pixel and the CLUT node and performing trilinear or tetrahedral interpolation.

18. The non-transitory, computer readable medium of claim 16, wherein the combined color shift of the CLUT node comprises an average weighted color shift computed by averaging together all of the weighted color shifts corresponding to the CLUT node.

19. The non-transitory, computer readable medium of claim 15, wherein identifying a color shift between the original pixel and the adjusted pixel comprises identifying a device space color value difference between the original pixel and the adjusted pixel for each color component.

20. The non-transitory, computer readable medium of claim 15, comprising instruction modules configured to direct the processor to identify whether the adjusted image includes spatial modifications as compared to the original image.
